(19) United States
(12) Patent Application Publication
(10) Pub. No.: US 2004/0155814 A1
(43) Pub. Date: Aug. 12, 2004

(54) Communication device for transmitting or receiving location information and determining relative location information

(76) Inventor: Michael R. Bascobert, Clarkston, MI (US)

Correspondence Address: Michael R. Bascobert, 6623 Greene Haven, Clarkston, MI, 48348, US

(21) Appl. No.: 10/364,757

(22) Filed: Feb. 11, 2003

(51) Int. Cl. G01S 5/14

(52) U.S. Cl. 342/357.08; 342/357.1

(57) ABSTRACT

The present invention includes a communication device that transmits its location information to a second communication device. The second communication device then uses this information and its own location information to determine relative distance information between the two devices.

### FIELD OF THE INVENTION

The present invention generally relates to a communication device, and more particularly, the present invention relates to a communication device for transmitting or receiving location information.

### BACKGROUND OF THE INVENTION

Conventionally, communication media such as cell phones, CB radios, marine radios, and traditional hard wired network telephones allow communication between one source communication device and a destination communication device. Also, navigation systems currently exist that include GPS (global positioning system) and Loran to allow people to determine their location in the world. Examples of GPS and cell phones include U.S. Pat. No. 6,501,420 entitled Mobile Cellular Telephone Comprising A GPS Receiver hereby incorporated by reference; U.S. Pat. No. 6,473,030 entitled Infrastructure-Aiding For Satellite Navigation Receiver And Method, hereby incorporated by reference.

### SUMMARY OF THE INVENTION

The present invention includes a communication device that transmits its location information to a second communication device. The second communication device then uses this information and its own location information to determine relative distance information between the two devices.

Other aspects of the invention will be apparent to those skilled in the art after reviewing the drawings and the detailed description below.

### BRIEF DESCRIPTION OF THE DRAWINGS

The present invention will now be described, by way of example, with reference to the accompanying drawings, in which:

FIG. 1 is a schematic view of a communication and location device according to the present invention;

FIG. 1a is a schematic view of a communication and location device according to the present invention;

FIG. 2 is a schematic view of a communication and location device according to the present invention;

FIG. 3 is a schematic view of a communication and location device according to the present invention; and

FIG. 4 is a schematic view of a communication and location device according to the present invention;

FIG. 5 is a schematic view of a communication and location device according to the present invention; and

FIG. 6 is a schematic view of a communication and location device according to the present invention.

### DETAILED DESCRIPTION OF THE EMBODIMENTS

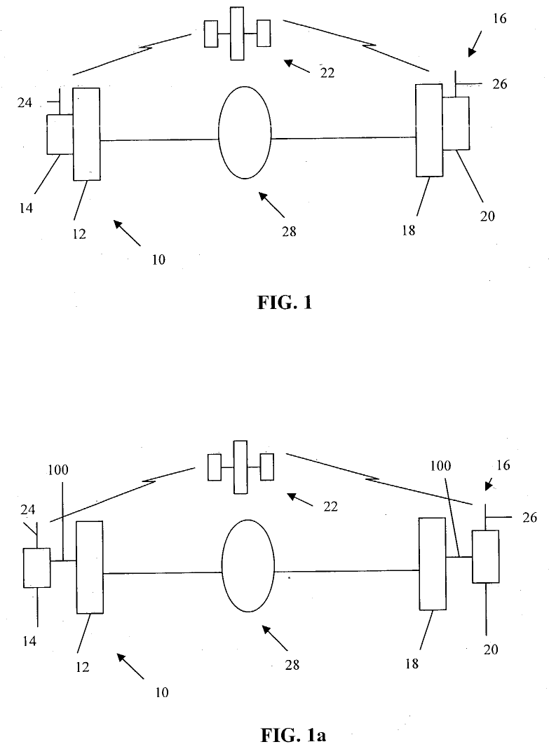

Referring now to FIG. 1, the present invention is shown and described. In FIG. 1, a communication/location device 10 is shown being used in conjunction with a communication/location device 16. The communication/location device 10 includes communication portion 12 and location portion 14. The communication portion is preferably a cell phone, CB radio, Marine radio, traditional telephone or any other similar communication means. The location portion is preferably a GPS receiver, Loran receiver or other similar navigation device. The communication portion 12 can be rigidly attached to the location portion 4, such as would be for a cell phone. Or, the communication portion 12 can be separated from location portion 14 and connected by a cable or wire 100 as shown in FIG. 1a. However, communication portion 12 is preferably close to location portion 14 to allow both devices to be located at the same location for reasons that will be discussed in greater detail.

Antenna 24 extends from location portion 24 to allow it to receive location coordinates from source 22. Source 22 is preferably a GPS satellite, terrestrial or other similar transmitter/receiver for a navigation system. It should be noted, however, that antennas 24 or 26 can be replaced by any known devices for transmission or reception of communication or location information.

Communication/location device 16 likewise includes a communication portion 18, a location portion 20, and an antenna 26. As like elements operate the same way, the description for communication/location device 16 is omitted.

Communication media 28 provides a communication link between communication/location devices 10 and 16. Each communication portion is adapted to broadcast and receive on one or more of these communication medias. Communication media 28 can be FM, AM or other similar and known carrier wave technology, cellular terrestrial or extraterrestrial network or standard cable, fiber optic or copper, internet, intranet, POTS (plain old telephone system) or other similar system.

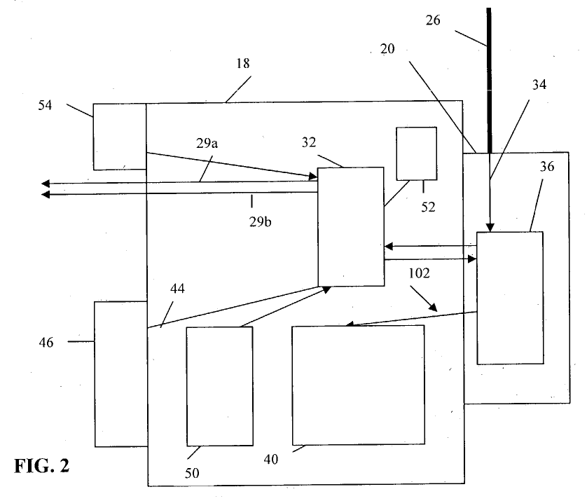

Referring to FIG. 2, communication/location device 16 is described in greater detail. As communication/location device 10 preferably operates the same as communication/location device 16, it is understood that the following description applies to both.

In FIG. 2, location portion 20 is shown including a circuit 36. Likewise, communication portion 18 is shown including a circuit 32. Either of these elements can be any known circuit for performing its function that may include modulators, demodulators, processors and software driven computers or other suitable control devices. A display or other similar device 40 is shown being coupled to the circuit 32 for displaying or directing a user of the location portion 20. This display can be LCD, LED, TFT or other known device for displaying electronic information.

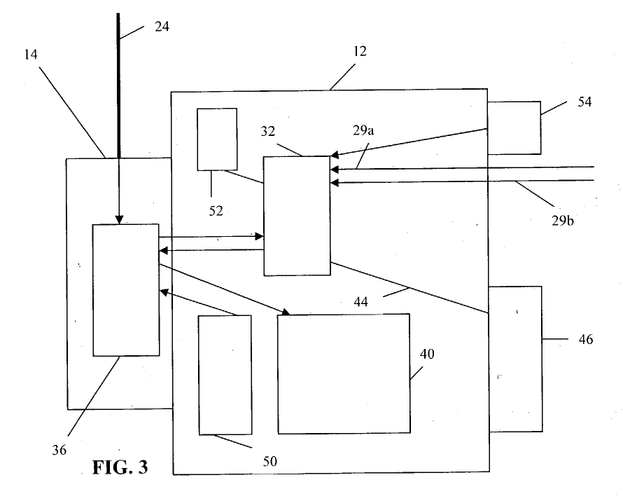

Referring now to FIGS. 1-3, the operation of the present invention is shown and described. In operation, communication/location device 10 receives location information from source 22. This information is received through antenna 24 and fed into circuit 36 to process the information and determine a location of the location portion 14. The processed location information is then fed to circuit 32 of the communication portion 12. It is understood that circuits 32 and 36 can be one circuit, and the present invention is not limited to that disclosed herein. Moreover, the circuits can be co-located in either one of the communication or location portions, and do not have to reside in separate places as illustrated in the embodiments.

The information, if desired, can also be displayed on display 40 as coordinates, a map showing the location, or other suitable means to show a user of communication/location device 10 where he or she is. This is accomplished by sending the information from the circuit 32 to the display 40 via connection 102. Circuit 32 dispatches a communication/location signal 30 via communication media 28 to communication/location device 16. This may be in the form of a phone call across a cellular network, Marine radio broadcast or CB radio broadcast or any other mentioned broadcast and media of communication media 28. Preferably, the communication/location signal includes both communication data 29a, such as a user's transmitted speech or other unrelated information, with location data 29b piggybacked to the communication data 29a of the signal. The communication data 29a is obtained from user input/output portion 46, which may be in the form of a speaker, transducer or other similar known means of vocalization. Additionally, the communication data is not limited to voice data and instead can be any form of communication data that is unrelated to the location data 29b. The location data is obtained from the processed location information from circuit 36 of location portion 14. Of course, the location data 29b can also be not accompanied by the communication data and be sent by itself. The communication data 29a can occupy a different portion of the used bandwidth of communication media 28 to allow ease of deciphering. Alternatively, the location information can be modulated into the communication data 29a or vice versa. The communication information and location information can also occupy different bandwidths. The communication data can also replace a portion of a bandwidth occupied by the communication information or vice versa. However, any known coding technique can also be used.

The format of the communication/location signal is preferably in the format of a data stream, such that the communication/location signal carries with it coded information that can be deciphered by the communication/location device 16. Such a signal can be created and read by modulation and demodulation or other suitable techniques. Communication/location device 16 receives the location information and feeds it to its circuit 32, which can include a demodulation device, to recover the location information. The communication data 29a is fed to its input/output portion 46. The location information is fed to circuit 36. Circuit 36 of communication/location device 16 receives location information from source 22 the same way as communication/location device 10 and determines its location. By now knowing the location of both devices 10 and 16, circuit 36 of communication/location device 16 processes both the received location information 29b from communication/location device 10 as well as its own location information from source 22 to determine a distance and direction of communication/location device 10 with respect to communication/location device 16. Circuit 36 of device 16 then sends this calculated information to display 40 of communication/location device 16 to display this information in the form of an arrow, distance, path on a map or other means, or other similar configuration. Communication/location device 16 can then send its location information, determined from source 22, to communication/location device 10 to allow device 10 to similarly calculate the distance between the two devices. Or, communication/location device 16 can merely send the calculated information back to the communication/location device 10, and allow circuit 32 of device 10 to directly send the information to its display 40. As the location information is preferably constantly received from source 22 and transmitted via communication media 28, the calculated information in both devices is preferably constantly updated. Moreover, other information such as relative speed between the two devices can also be calculated.

Circuit 32 can also be configured with mapping software such that it generates a street map showing the most ideal rout to take to meet the user of the other communication/location device. The street map can include distance between the two devices 10 and 16 as well as estimated time of arrival based on the traveling speed of one or both of the devices 10 and 16. To utilize this feature, storage facility 50, which may be in the form of a data base or other suitable computer storage medium, includes data representing various locations. For instance, storage facility 50 can be a data base having data for every restaurant in the city of Washington, maps of all streets throughout the United States or other country, or other similar information. Circuit 32 uses this information to identify locations in conjunction with the location information and outputs corresponding information, such as the location of the users on a map in the users' area to the output device 40.

Each communication/location device 10 and 16 is preferably equipped with a second storage medium 52. Second storage medium 52 maintains a store of the most previous received coordinates from the other communication/storage device. The second message storage medium 52 is constantly updated with new location information transmitted from the other communication/storage device. Circuit 32 then draws from the second message storage medium to calculate the distance or direction between the two communication/storage devices. In this way, devices without a dedicated communication channel or which transmit on an irregular basis, such as marine radios or CB radios, do not need to be receiving a transmission to obtain the required location information needed to determine the distance and direction of the other communication/location device. The second storage device 52 can either be updated whenever a new communication is received, or an input output device on the communication/location device can be used to instruct the circuit to use the current value stored in the second storage area 52 as the value to be used for determining the distance and direction information. By this way, if multiple users are broadcasting on a broadcast frequency, the user of the communication/storage device can select a desired one of the broadcasters as the desired location information.

In another embodiment, the communication/location device only broadcasts the location information if requested by the user. Accordingly, once communication is established between the two devices, the user using communication/location device 10 or 16 inputs a request through input device 54, such as by pushing the # key on a touch pad of a cellular telephone, to instruct circuit 32 of their communication/location device to dispatch the location information. Circuit 32 dispatches the location information on receipt of the request. This serves to protect the privacy of a user of any communication/location device from giving out the location information when such is not desired as well as preserving bandwidth and battery life.

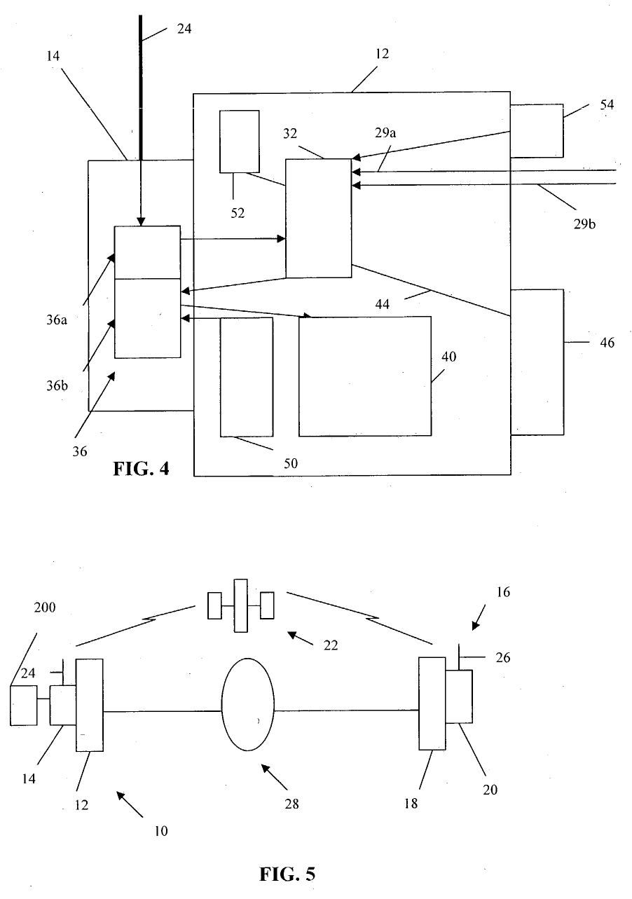

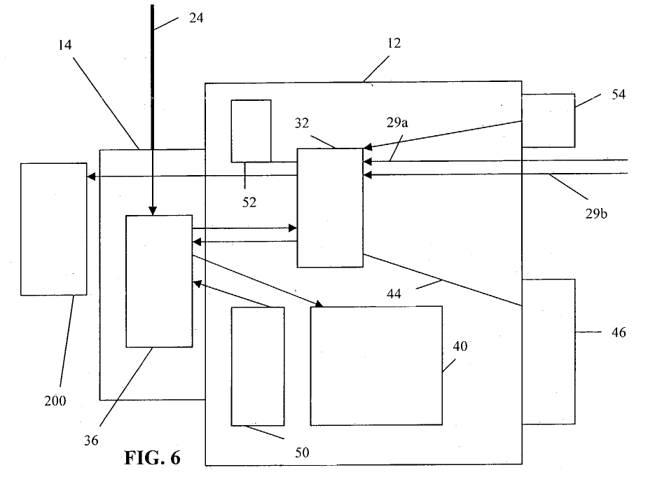

In another aspect of the present invention, the communication/location device 16 is used in conjunction with a vehicle navigation system 200. As shown in FIGS. 5 and 6, the communication/location device 16 is plugged into the vehicle navigation system 200. The communication/location device 10 is located at a location, such as a destination store or restaurant, and communication/location device 16 is being used by an individual searching or looking for the destination via a car containing the vehicle navigation system 200. The individual places a call to the destination communication/location device 10 and requests location information as described above. The transmitted information is transmitted from the communication/location device 10 to communication/location device 16. The communication/location device 16 then feeds this information into the vehicle navigation system 200 such that the vehicle navigation system processes the information and generates a map or other known direction information to allow the user to travel to the destination.

The present invention will allow restaurant owners to easily transmit their location information to drivers in vehicles if the driver were to call the restaurant looking for directions, allow two individuals to find each other at a busy location, or provide other similar features.

It should be understood that the communication portion and location portion can be combined into one unit using one circuit and one antenna, and the present invention is not limited to two separate components. In such a configuration, the circuits for the communication portion and the location portion would preferably be the same. Moreover, the communication portion and location portion do not need to be physically connected and can be separate components. Furthermore, it should be understood that the present invention is not limited to two communication/location devices and instead can be also used with more than two communication/location devices 10 and 16.

Referring to FIG. 4, the circuit 36 is shown being composed of circuit 36a and 36b.

In FIG. 1a, the communication portions of each communication are shown as not being attached to each other. The connection between these portions can be by hard wire, wireless or other similar means. Preferably, however, the communication portion is proximate the location portion such that the location information for the location portion generally applies to the communication portion. Such a system may be used where separate devices, such as an existing GPS receiver is plugged into a cell phone or marine radio.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A communication/location device comprising:
a location portion including a location circuit configured to determine location information representing a geographical location of the location portion from a navigation system; and
a communication portion including a communication circuit adapted to receive a second location information from a second communication/location device over a communication media;
wherein the location circuit is connected to the communication circuit and is adapted to determine at least a distance, direction or path between the communication/location device and the second communication/location device based on the location information and the received second location information.

2. The communication/location device according to claim 1, wherein the communication portion is a cell phone, the location portion is a GPS receiver, and the communications media is a cellular network.

3. The communication/location device according to claim 1, wherein the communication portion is a Marine radio transmitter/receiver and the location portion is a GPS receiver.

4. The communication/location device according to claim 1, wherein the communication portion is a CB radio and the location portion is a GPS receiver, wherein the communication media is a broadcast frequency.

5. The communication/location device according to claim 1, wherein the communication portion dispatches the location information to the second communication/location device as a transmitted data stream.

6. The communication/location device according to claim 5, wherein the communication portion includes an input device electrically connected to the communication circuit, wherein the communication circuit is configured to only dispatch the location information to the second communication/location device in response to a request from the input device.

7. The communication/location device according to claim 1, wherein:
the communication circuit is adapted to receive the location information and communication information; and
the circuit is adapted to recover the location information from the communication information; and
the circuit is connected to an input/output device to dispatch the communication information to the input/output device;
the communication circuit is connected to the location circuit to dispatch the location information to the location circuit.

8. The communication/location device according to claim 7, wherein the communication information is voice information.

9. The communication/location device according to claim 1, further comprising a storage facility adapted to store geographic data information, wherein the circuit is adapted to use the geographic data information to coordinate the location of at least the communication/location device or the second communication/location device with the geographical data information.

10. The communication/location device according to claim 1, further comprising a storage area adapted to store the second location information received from the second communication/location device, wherein the circuit is adapted to use the stored second location information to determine the distance, direction or path.

11. The communication/location device according to claim 10, wherein the stored second location information is a most recently received second location information.

12. A communication/location system comprising:
at least a first communication/location device comprising:
a first location portion including a location circuit adapted to determine a first location information representing a geographical location of the first location portion from a navigation system;
a first communication portion including a first communication circuit adapted to receive a second location information from a second communication/location device, wherein the first communication portion is adapted to transmit the first location information to the second communication/location device as a first transmitted data stream, wherein the first communication portion is adapted to receive the second location information from the second communication/location device in a form of a second transmitted data stream, wherein the first communication portion is adapted to receive the second transmitted data stream over a communication media; and
wherein the location circuit is connected to the communication circuit and adapted to determine at least a distance, direction or path between the first communication/location device and the second communication/location device based on the first location information and the received second location information;
at least the second communication/location device comprising:
a second communication portion adapted to receive the first location information from the first communication/location device, wherein the second communication portion is adapted to transmit the second location information to the first communication/location device in a form of the second transmitted data stream, wherein the second communication portion is adapted to receive the first location information from the first communication/location device in a form of the first transmitted data stream, wherein the second communication portion is adapted to receive the first transmitted data stream from the first communication/location device over at least any one of the wireless network, the cellular network, the telephone network, or the broadcast frequency; and
a second circuit adapted to determine at least the distance, direction or path between the first communication/location device and the second communication/location device based on the received first location information and the second location information.

13. The communication/location system according to claim 12, further comprising the communication media, wherein the communication media is the cellular network, wireless network or telephone network.

14. The communication/location device according to claim 12, wherein the first communication portion is a first cellular phone and the second communication portion is a second cellular phone, wherein the first location portion is a first GPS receiver and the second location portion is a second GPS receiver, wherein the communications media is a cellular network or a wireless network.

15. The communication/location device according to claim 12, wherein the first communication portion is a Marine radio transmitter/receiver and the second communication portion is a second marine radio, wherein the first location portion is a first GPS receiver and the second location portion is a second GPS receiver.

16. The communication/location device according to claim 12, wherein:
the communication portion includes a first input device electrically connected to the first circuit, wherein the first circuit is responsive to the first input device to dispatch the first location information to the second communication/location device; and
the second communication portion includes a second input device electrically connected to the second circuit, wherein the second circuit is responsive to the second input device to dispatch the second location information to the first communication/location device.

17. The communication/location device according to claim 12, wherein:
the first communication portion is adapted to receive the first location data stream with a first communication data stream and the second communication portion is adapted to receive the second location data stream with a second communication data stream;
the first circuit is adapted to decipher the first data stream from the first communication data stream and the second circuit is adapted to decipher the second data stream from the second communication data stream;
the first circuit is adapted to dispatch the first communication data stream to a first input/output device and to determine the distance, location or path from the first location information and the second data stream; and
the second circuit is adapted to dispatch the second communication data stream to a second input/output device and to determine the distance, location or path from the second location information and the first data stream

18. A method for determining location information between at least a first communication/location device and at least a second communication/location device, the method comprising the steps of:
determining a first location information of the first communication/location device from a navigation system;
receiving second location information from the second communication/location device over a broadcast media;
processing the first location information and the received second location information in the first communication/location device to determine at least a distance, direction or path between the first communication/location device and the second/communication location device.

19. The method according to claim 18, further comprising the steps of:
determining, at the second communication/location device, the second location information from the navigation system; and
transmitting the second location information from the second communication/location device to the first communication/location device.

20. The method according to claim 18, wherein the first communication/location device includes a cell phone that receives the second location information during the receiving step, wherein a GPS receiver determines the first location information from the navigation system.

21. The communication/location device according to claim 18, wherein the first communication/location device includes a radio transmitter/receiver that receives the second location information, wherein the first location information is determined by a GPS receiver that determines the first location information from the navigation system.

22. The method according to claim 19, further comprising the step of requesting the second communication/location device to transmit the second location information during the transmitting step, wherein the step of requesting is accomplished by entering a selection into an input/output device on the second communication/location device.

23. The method according to claim 18, further comprising the steps of:
receiving communication information with the location information during the receiving step;
deciphering the location information from the communication information; and
dispatching the communication information to an input/output device and determining the distance, direction or path from the first location information and the second location information.

24. The method according to claim 23, wherein the communication information is voice information.

25. The method according to claim 18, further comprising the steps of:
providing a storage facility that stores geographic data information; and
using the stored geographic data information to coordinate the location of at least the communication/location device or the second communication/location device with the geographical data information.

26. The method according to claim 18, further comprising the steps of:
storing the second location information at the first communication/location device; and
retrieving the stored location information to determine the distance, direction or path.

27. The method according to claim 26, wherein the stored second location information is a most recently received second location information.
